(19) United States
(12) Patent Application Publication
(10) Pub. No.: US 2024/0262969 A1
(43) Pub. Date: Aug. 8, 2024

(54) MONOLAYER BLOWN FILM

(71) Applicant: BOREALIS AG, Vienna (AT)

(72) Inventors: Jingbo WANG, Linz (AT); Friedrich BERGER, Linz (AT); Jani AHO, Porvoo (FI)

(73) Assignee: BOREALIS AG, Vienna (AT)

(21) Appl. No.: 18/576,833

(22) PCT Filed: Jul. 5, 2022
(86) PCT No.: PCT/EP2022/068499

§ 371 Date: Jan. 5, 2024

(30) Foreign Application Priority Data
Jul. 7, 2021 (EP) 21184142.4

(51) Int. Cl. C08J 5/18

(52) U.S. Cl. CPC C08J 5/18; C08J 2323/06; C08J 2423/08

(57) ABSTRACT

Monolayer blown films including a specific blend of Ziegler-Natta catalysed linear low density polyethylene (znLLDPE) and a specific multimodal metallocene catalysed LLDPE, with well-balanced mechanical properties, especially dart drop (impact strength) and tensile modulus.

The present invention relates to monolayer blown films comprising a specific blend of Ziegler-Natta catalysed linear low density polyethylene (znLLDPE) and a specific multimodal metallocene catalysed LLDPE, with well-balanced mechanical properties, especially dart drop (impact strength) and tensile modulus.

High standards are nowadays required for packaging materials. Quite often properties are required in the packaging industry, which are conflicting. Typically, high stiffness and toughness are required in parallel. To achieve these different properties seldom pure components, but rather combinations of different polymer components are used. Two different approaches mainly are at the skilled person's disposal: (a) blends of two or more polymers to form a heterophasic structure, or (b) producing a multilayer structure with different materials providing different functions. Both of them are applied in industry.

Due to the different requirements nowadays multilayer packaging with different type of materials are used, which from one side serve the needs, but from the other side such structures make recycling difficult. Therefore using pure materials is preferred, i.e. a packaging with ‘mono-materials’ is really appreciated. However, this imposes higher requirement to the performance of materials themselves, a material with balanced performance is therefore highly appreciated.

One way to improve the performances of one material is, e.g. to blend two polyethylenes, e.g. mLLDPE with znLLDPE, which is in principle well known. However, there is still room for further improvement. Higher stiffness/impact strength is still required.

As stated above the recycling of packaging material after their first use is an important topic nowadays. It is much more challenging to recycle packaging films made of different materials, e.g. different plastics, than to recycle mono-material solutions. On the other hand, the use of different materials is sometimes necessary to obtain acceptable properties, like mechanical properties. Therefore, another objective of the present invention is the provision of a polyethylene based mono-material solution, which shows well-balanced mechanical properties, especially dart drop (impact strength) and tensile modulus.

The present inventors have found that a monolayer polyethylene blown film comprising certain carefully selected components, provides films with well-balanced mechanical properties, especially dart drop (impact strength) and tensile modulus.

### SUMMARY OF INVENTION

The present invention is therefore directed to a monolayer polyethylene blown film comprising
a) 50.0 wt % to 95.0 wt %, based on the total weight of the monolayer polyethylene blown film, of a multimodal Ziegler-Natta catalysed linear low density polyethylene (znLLDPE) having a density in the range of from 925 to 950 kg/m³ (ISO 1183) and an MFR₅ (190° C., 5 kg, ISO 1133) in the range of from 0.1 to 6.0 g/10 min; and
b) 5.0 wt % to 50.0 wt %, based on the total weight of the monolayer polyethylene blown film, of a multimodal metallocene catalysed linear low density polyethylene (mLLDPE) having a density in the range of from 880 to 925 kg/m³ (ISO 1183), an MFR₂ (190° C., 2.16 kg, ISO 1133) in the range of from 0.1 to 6.0 g/10 min and a ratio of the MFR₂₁ (190° C., 21.6 kg, ISO 1133) to MFR₂ (190° C., 2.16 kg, ISO 1133), MFR₂₁/MFR₂, in the range of from 22 to 50; the total amounts of a)+b) summing up to 100 wt %.

In an embodiment the first multimodal metallocene catalysed linear low density polyethylene (mLLDPE) consists of an ethylene polymer component (A), which consists of an ethylene polymer fraction (A-1) and an ethylene polymer fraction (A-2), and an ethylene polymer component (B).

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed linear low density polyethylene (mLLDPE) is defined in this invention as linear low density polyethylene copolymer, which has been produced in the presence of a metallocene catalyst.

Ziegler-Natta catalysed linear low density polyethylene (znLLDPE) is defined in this invention as linear low density polyethylene copolymer, which has been produced in the presence of a Ziegler-Natta catalyst.

Term “multimodal” in context of multimodal linear low density polyethylene means herein multimodality with respect to melt flow rate (MFR). The multimodal linear low density polyethylene can have further multimodality with respect to one or more further properties, like density, comonomer type and/or comonomer content, as will be described later below.

### DETAILED DESCRIPTION OF INVENTION

The film of the invention is a monolayer polyethylene blown film comprising a blend of a multimodal Ziegler-Natta catalysed linear low density polyethylene (znLLDPE) and a multimodal metallocene catalysed linear low density polyethylene (mLLDPE) The monolayer is composed of polyethylene polymers only, i.e. no other polymer than an ethylene based polymer is present.

The monolayer polyethylene blown film according to the invention comprises
a) 50.0 wt % to 95.0 wt %, based on the total weight of the monolayer polyethylene blown film, of a multimodal Ziegler-Natta catalysed linear low density polyethylene (znLLDPE) having a density in the range of from 925 to 950 kg/m³ (ISO 1183) and an MFR₅ (190° C., 5 kg, ISO 1133) in the range of from 0.1 to 6.0 g/10 min; and
b) 5.0 wt % to 50.0 wt %, based on the total weight of the monolayer polyethylene blown film, of a multimodal metallocene catalysed linear low density polyethylene (mLLDPE) having a density in the range of from 880 to 925 kg/m³ (ISO 1183), an MFR₂ (190° C., 2.16 kg, ISO 1133) in the range of from 0.1 to 6.0 g/10 min and a ratio of the MFR₂₁ (190° C., 21.6 kg, ISO 1133) to MFR₂ (190° C., 2.16 kg, ISO 1133), MFR₂₁/MFR₂, in the range of from 22 to 50; the total amounts of a)+b) summing up to 100 wt %.

Preferably, the monolayer consists of the znLLDPE and the mLLDPE.

Preferably, the znLLDPE is present in an amount of 52.0 to 93.0 wt %, more preferably of 55.0 to 90.0 wt %, based on the total weight of the monolayer.

Thus, the mLLDPE is preferably present in an amount of 7.0 to 48.0 wt % and more preferably of 10.0 to 45.0 wt %, based on the total weight of the monolayer.

Ad Multimodal Ziegler-Natta Catalysed Linear Low Density Polyethylene (znLLDPE)

The multimodal Ziegler-Natta catalysed linear low density polyethylene (znLLDPE) has a density (ISO 1183) in the range of from 925 to 950 kg/m³, preferably from 927 to 948 kg/m³, more preferably from 928 to 945 kg/m³, and even more preferably from 930 to 943 kg/m³.

The MFR₅ (190° C., 5 kg, ISO 1133) of the znLLDPE is in the range of from 0.1 to 6.0 g/10 min, preferably from 0.3 to 5.0 g/10 min, more preferably from 0.5 to 3.0 g/10 min, and even more preferably from 0.7 to 2.5 g/10 min.

The znLLDPE contains at least one or two comonomer(s). Suitable comonomers are C₃-C₁₀ alpha-olefin comonomers.

Thus, the znLLDPE can be a copolymer of ethylene and one C₃-C₁₀ alpha-olefin comonomer or a terpolymer of ethylene and two different C₃-C₁₀ alpha-olefin comonomers.

Preferably, the comonomers are selected from the group of 1-butene, 1-hexene and 1-octene.

It is preferred if the comonomer employed is 1-butene and/or 1-hexene.

More preferred are terpolymers comprising 1-butene and 1-hexene comonomers.

The total comonomer content of the znLLDPE is preferably in the range of from 0.3 to 7.0 mol %, more preferably of from 0.6 to 4.5 mol % and even more preferably of from 1.5 to 3.5 mol %.

1-butene is preferably present in an amount of from 0.1 to 3.0 mol %, more preferably of from 0.2 to 2.0 mol %, and even more preferably of from 0.3 to 1.5 mol % and 1-hexene is present in an amount of from 0.2 to 4.0 mol %, more preferably of from 0.4 to 2.5 mol % and even more preferably of from 0.7 to 2.0 mol %.

In one embodiment of the monolayer film according to the invention, the znLLDPE comprises
(A) a lower molecular weight (LMW) homopolymer of ethylene and
(B) a higher molecular weight (HMW) terpolymer of ethylene, 1-butene and 1-hexene.

The LMW homopolymer fraction (A) has a lower molecular weight than the HMW terpolymer fraction (B).

In a further embodiment of the present invention the lower molecular weight (LMW) homopolymer of ethylene (A) consists of one or two fractions, i.e. of one ore two homopolymers of ethylene.

In case that the lower molecular weight (LMW) homopolymer of ethylene (A) consists of two homopolymers of ethylene, these two fractions are named (A-1) and (A-2)

The lower molecular weight homopolymer (A) of the znLLDPE has a melt index MFR₂ according to ISO 1133 (190° C.) in the range of from 200 to 1000 g/10 min, preferably of from 250 to 800 g/10 min; a density according to ISO 1183 in the range of from 940 to 980 kg/m³, preferably 945 to 975 kg/m³ and a comonomer content in the range of from 0 to 2.5 mol %, preferably from 0 to 2.0 mol %.

The amount of the lower molecular weight fraction (A) of the znLLDPE is in the range of 30 to 60 wt %, preferably 35 to 50 wt % and more preferably 35 to 45 wt %.

The expression “homopolymer of ethylene” used herein refers to a polyethylene that consists substantially, i.e. to at least 98.0 wt %, preferably at least 99.0 wt % and more preferably at least 99.5 wt % by weight, like at least 99.8 wt % of ethylene.

In case that the lower molecular weight (LMW) homopolymer of ethylene (A) consists of two homopolymers of ethylene, i.e. fractions (A-1) and (A-2), these two fractions preferably have a different MFR₂ according to ISO 1133 (190° C.).

The homopolymer fraction (A-1) preferably has a MFR₂ according to ISO 1133 (190° C.) in the range of 100 to 400 g/10 min, more preferably in the range of 150 to 300 g/10 min, whereas the homopolymer fraction (A-2) preferably has a MFR₂ according to ISO 1133 (190° C.) in the range of 450 to 1200 g/10 min, more preferably in the range of 600 to 1100 g/10 min.

The MFR₂ of fraction (A-1) is preferably lower than the MFR₂ of the total lower molecular weight (LMW) homopolymer of ethylene (A).

According to a preferred embodiment the ratio of MFR₂(A-1)/MFR₂ (A) may be for example between greater than 1 and up to 10, preferably between 1.5 and 5, such as 1.5 to 4.

Ideally, the MFR difference between the first and second homopolymer fraction (A-1) and (A-2) is as high as possible.

Ideally, the MFR difference between the first homopolymer fraction (A-1) and the MFR₂ of the total lower molecular weight (LMW) homopolymer of ethylene (A) is as high as possible e.g.

MFR₂ of first homopolymer fraction (A-1) may be at least 50 g/10 min, such as at least 100 g/10 min such as 100 to 200 g/10 min lower than the MFR₂ of the total lower molecular weight (LMW) homopolymer of ethylene (A).

The density of the two homopolymer fractions (A-1) and (A-2) may be the same or may be different and is in the range of 955 to 980 kg/m³, preferably 965 to 980 kg/m³ or 965 to 975 kg/m³.

In an embodiment of the present invention the density of homopolymer fractions (A-1) and (A-2) are the same or differ+/−5 kg/m³, preferably +/−2 kg/m³.

The total lower molecular weight (LMW) homopolymer of ethylene (A) may comprise 30 to 60 wt % of the first ethylene homopolymer fraction (A-1) and 70 to 40 wt % of the second ethylene homopolymer fraction (A-2). In some embodiments, there is an excess of the second ethylene homopolymer fraction (A-2), e.g. 54 to 70 wt % of the second ethylene homopolymer fraction (A-2).

In another embodiment the total lower molecular weight (LMW) homopolymer of ethylene (A) contains the same amount of first and second ethylene homopolymer fractions (A-1) and (A-2).

The higher molecular weight fraction (B) has a lower MFR₂ and a lower density than the lower molecular weight fraction (A).

Preferably, the znLLDPE is produced in a multi-stage, e.g. two-stage or three-stage polymerization using the same Ziegler-Natta catalyst in all stages. Preferably, the znLLDPE is made using a slurry polymerization in at least one loop reactor followed by a gas phase polymerization in a gas phase reactor.

A loop reactor—gas phase reactor system or loop—loop—gas phase reactor system is well known as Borealis technology, i.e. a BORSTAR® reactor system.

In one embodiment, the znLLDPE is thus preferably formed in a two-stage process comprising a first slurry loop polymerization followed by gas phase polymerization in the presence of a Ziegler-Natta catalyst.

Preferably, the lower molecular weight fraction (A) is produced in a continuously operating loop reactor where ethylene is polymerized in the presence of a Ziegler-Natta catalyst and the higher molecular weight fraction (B) is then formed in a gas phase reactor using the same Ziegler-Natta catalyst.

Such znLLDPEs are known in the state of the art and are described e.g. in WO 03/066698 or WO 2008/034630 or are commercially available, such as BorShape™ FX1001 and BorShape™ FX1002 (both from Borealis AG).

In another embodiment the znLLDPE is preferably formed in a three-stage process preferably comprising a first slurry reactor (loop reactor 1), whereby the first slurry loop reactor is connected in series with another slurry reactor (loop reactor 2), so that the first homopolymer fraction (A-1) produced in the loop reactor 1 is fed to the loop reactor 2, wherein the second homopolymer fraction (A-2) is produced in the presence of the first fraction (A-1). The loop reactor 2 is thereby connected in series to a gas phase reactor (GPR), so that the total molecular weight fraction (A) leaving the second slurry reactor is fed to the GPR to produce the znLLDPE. In this case, the reaction conditions in the two slurry reactors are chosen in a way that in the two slurry reactors different products in view of MFR and/or density are produced.

Such a process is described inter alia in WO 2016/198273.

A suitable process is the Borstar PE 3G process.

Additionally the znLLDPE, preferably the znLLDPE terpolymer may also contain one or more additives selected from antioxidants, process stabilizers, slip agents, pigments, UV-stabilizers and other additives known in the art.

Ad Multimodal Metallocene Catalysed Linear Low Density Polyethylene (mLLDPE)

The multimodal metallocene catalysed linear low density polyethylene (mLLDPE) has a density (ISO 1183) in the range of from 880 to 925 kg/m³, preferably in the range of from 890 to 922 kg/m³ and more preferably in the range of from 900 to 918 kg/m³.

The MFR₂ (190° C., 2.16 kg, ISO 1133) of the first multimodal metallocene catalysed linear low density polyethylene (mLLDPE-1) is in the range of from 0.1 to 6.0 g/10 min, preferably from 0.3 to 4.0 g/10 min, more preferably from 0.5 to 3.0 g/10 min and even more preferably from 0.8 to 2.0.

The multimodal metallocene catalysed linear low density polyethylene (mLLDPE) further has a ratio of the MFR₂₁ (190° C., 21.6 kg, ISO 1133) to MFR₂ (190° C., 2.16 kg, ISO 1133), MFR₂₁/MFR₂, in the range of from 22 to 50, preferably from 25 to 40, more preferably from 28 to 35.

The multimodal metallocene catalysed linear low density polyethylene (mLLDPE) is a copolymer of ethylene with at least two different comonomers selected from alpha-olefins having from 4 to 10 carbon atoms, e.g. 1-butene, 1-hexene, 1-octene, preferably 1-butene and 1-hexene.

The total amount of 1-butene, based on the multimodal metallocene catalysed linear low density polyethylene (mLLDPE), is in the range of from 0.1 to 1.0 wt %, preferably 0.2 to 0.8 wt % and more preferably 0.3 to 0.6 wt %.

The total amount of 1-hexene, based on multimodal metallocene catalysed linear low density polyethylene (mLLDPE), is in the range of from 2.0 to 20.0 wt %, preferably 4.0 to 18.0 wt % and more preferably 6.0 to 15.0 wt %.

In an embodiment, the multimodal metallocene catalysed linear low density polyethylene (mLLDPE) consists of an ethylene polymer component (A), which consists of an ethylene polymer fraction (A-1) and an ethylene polymer fraction (A-2), and an ethylene polymer component (B).

Preferably, the alpha-olefin comonomer having from 4 to 10 carbon atoms of ethylene polymer component (A) is different from the alpha-olefin comonomer having from 4 to 10 carbon atoms of ethylene polymer component (B), more preferably the alpha-olefin comonomer having from 4 to 10 carbon atoms of ethylene polymer component (A) is selected from 1-butene, 1-hexene and 1-octene, more preferably is 1-butene; and the alpha-olefin comonomer having from 4 to 10 carbon atoms of ethylene polymer component (B) is preferably selected from 1-hexene and 1-octene, more preferably is 1-hexene.

The comonomer type for the polymer fractions (A-1) and (A-2) is the same, thus the same alpha-olefin comonomer having from 4 to 10 carbon atoms is used for fraction (A-1) and (A-2), more preferably both fractions therefore have 1-butene as comonomer.

The total amount (wt %) of 1-butene present in the ethylene polymer component (A) is in the range of from 0.5 to 5.0 wt %, preferably of from 0.6 to 4.0 wt %, more preferably of from 0.8 to 3.0 wt %, even more preferably of from 1.0 to 2.0 wt %, based on the ethylene polymer component (A).

The total amount (wt %) of 1-hexene, present in the ethylene polymer component (B) is in the range of from 15.0 to 25.0 wt %, preferably of from 16.0 to 22.0 wt %, more preferably of from 17.0 to 20.0 wt %, based on the ethylene polymer component (B).

The multimodal metallocene catalysed linear low density polyethylene (mLLDPE) is referred herein as “multimodal”, since the ethylene polymer component (A), including ethylene polymer fractions (A-1) and (A-2), and ethylene polymer component (B) have been produced under different polymerization conditions resulting in different Melt Flow Rates (MFR, e.g. MFR₂).

I.e. the multimodal metallocene catalysed linear low density polyethylene (mLLDPE) is multimodal at least with respect to difference in MFR of the ethylene polymer components (A) and (B).

The MFR₂ of the ethylene polymer fractions (A-1) and (A-2) may be different from each other, i.e. ethylene polymer fractions (A-2) has a higher MFR₂ than ethylene polymer fractions (A-1), or may be the same.

The ethylene polymer fraction (A-1) has a MFR₂ (190° C., 2.16 kg, ISO 1133) in the range of from 1.0 to 15.0 g/10 min, preferably of from 1.5 to 13.0 g/10 min, more preferably of from 2.0 to 11.0 g/10 min and even more preferably of from 2.5 to 10.0 g/10 min.

The ethylene polymer fraction (A-2) preferably has a MFR₂ (190° C., 2.16 kg, ISO 1133) in the range of from 2.0 to 30.0 g/10 min, preferably of from 2.5 to 20.0 g/10 min, more preferably of from 3.0 to 15.0 g/10 min, like 3.5 to 10.0 g/10 min.

The MFR₂ of the ethylene polymer components (A) and (B) are also different from each other. The ethylene polymer component (A) has a MFR₂ in the range of from 2.0 to 30 g/10 min, preferably of from 2.5 to 20 g/10 min, more preferably of from 3.0 to 15 g/10 min and even more preferably of from 3.2 to 10 g/10 min.

The ethylene polymer component (B) has a MFR₂ in the range of from 0.01 to 1.5 g/10 min, preferably of from 0.05 to 1.2 g/10 min, more preferably of from 0.1 to 1.0 g/10 min and even more preferably of from 0.2 to 0.8 g/10 min.

In an embodiment of the invention it is preferred the ratio of the MFR₂ of ethylene polymer component (A) to the MFR₂ of the final mLLDPE is at least 2.5 to 20.0, preferably 3.0 to 15.0 and more preferably of 3.5 to 10.0.

Naturally, in addition to multimodality with respect to, i.e. difference between, the MFR₂ of ethylene polymer components (A) and (B), the mLLDPE of the invention can also be multimodal e.g. with respect to one or both of the two further properties:

multimodality with respect to, i.e. difference between,
the comonomer type and/or content(s) present in the ethylene polymer components (A) and (B); and/or
the density of the ethylene polymer components (A) and (B).

Even more preferably the mLLDPE used according the invention is further multimodal with respect to difference in density between the ethylene polymer component (A) and ethylene polymer component (B). Preferably, the density of ethylene polymer component (A) is different, preferably higher, than the density of the ethylene polymer component (B).

The density of the ethylene polymer component (A) is in the range of from 920 to 950 kg/m³, preferably of from 925 to 950 kg/m³, more preferably from 930 to 945 kg/m³ and/or the density of the ethylene polymer component (B) is in the range of from 880 to 915 kg/m³, preferably of from 885 to 910 kg/m³, and more preferably in the range of from 890 to 905 kg/m³.

The polymer fraction (A-1) has a density in the range of from 920 to 960 kg/m³, preferably of 925 to 955 kg/m³, more preferably of 930 to 950 kg/m³, like 935 to 945 kg/m³.

The density of the polymer fraction (A-2) is in the range of from 930 to 950 kg/m³, preferably of 935 to 945 kg/m³.

The density of polymer fractions (A-1) and (A-2) may be the same or may be different.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 30.0 to 70.0 wt % based on the mLLDPE, preferably in an amount of 32.0 to 55.0 wt % and even more preferably in an amount of 34.0 to 45.0 wt %.

Thus, the ethylene polymer component (B) is present in an amount of 70.0 to 30.0 wt % based on the mLLDPE, preferably in an amount of 68.0 to 45.0 wt % and more preferably in an amount of 66.0 to 55.0 wt %.

The mLLDPE can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce the mLLDPE. In this case, the reaction conditions in the two slurry reactors are chosen in a way that in the two slurry reactors different products in view of MFR and/or density are produced.

Such a process is described inter alia in WO 2016/198273, WO 2021/009189, WO 2021/009190, WO 2021/009191 and WO 2021/009192. Full details of how to prepare suitable mLLDPE-1 can be found in these references.

A suitable process is the Borstar PE 3G process.

The mLLDPE used according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases, it is necessary to introduce so much cocatalyst into the prepolymerization stage that a sufficient polymerization reaction is obtained therein. It is understood within the scope of the invention, that the amount or polymer produced in the prepolymerization lies within 1 to 5 wt % in respect to the final mLLDPE. This can counted as part of the first ethylene polymer component (A).

### Catalyst

The mLLDPE used according to the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

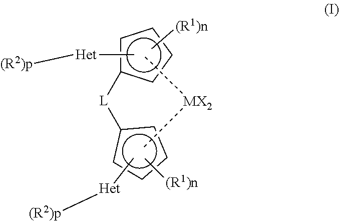

wherein each X is independently a halogen atom, a C₁₋₆-alkyl, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (1) has the structure

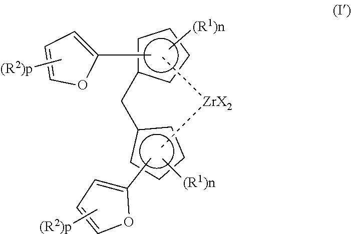

wherein each X is independently a halogen atom, a C₁₋₆-alkyl, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (1) are

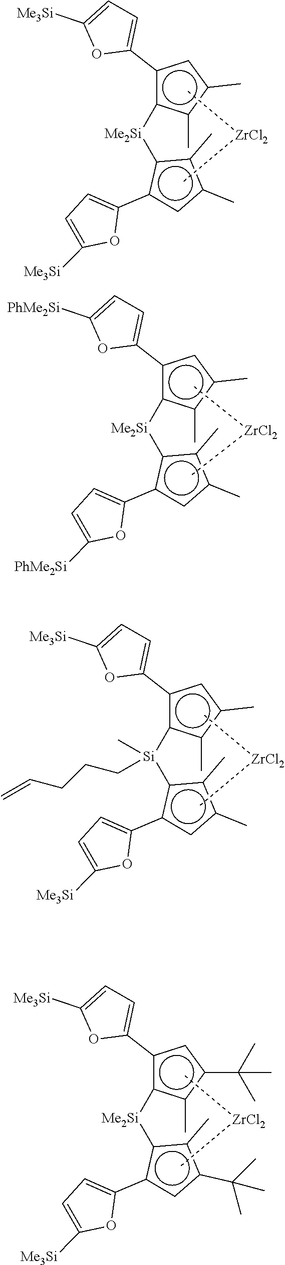

Most preferably the complex dimethylsilanediylbis[2-(5-trimethylsilylfuran-2-yl)-4,5-dimethylcyclopentadien-1-yl] zirconium dichloride is used.

More preferably the ethylene polymer components (A) and (B) of the mLLDPE are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred. Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The mLLDPE may optional contain additives and/or fillers.

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

### Monolayer Blown Film

The monolayer film of the invention can be prepared using blown extrusion techniques that are well known in the art. An appropriate blend of the components required for the layer can be blended and coextruded. It will be appreciated that the layer of the film of the invention may also contain standard polymer additives if required.

The monolayer film of the invention may have a thickness of 20 to 120 μm, preferably 30 to 100 μm and more preferably 40 to 80 μm. Films of the invention are preferably not stretched in the machine or transverse or biaxial direction.

The films of the invention are characterized by a dart-drop impact strength (DDI) determined according to ASTM D1709, method A on a 40 μm monolayer test blown film of at least 150 g up to 1200 g, preferably 200 g up to 1100 g and more preferably 250 g up to 1000 g.

Films according to the present invention furthermore have good stiffness (tensile modulus measured on a 40 μm monolayer test blown film according to ISO 527-3), i.e. >250 MPa (in both directions).

Thus, the films according to the present invention have in addition a tensile modulus (measured on a 40 μm monolayer test blown film according to ISO 527-3) in machine direction (MD) in the range of from >250 MPa to 700 MPa, preferably of from 300 MPa to 600 MPa and in transverse dircetion (TD) in the range of from >300 MPa to 800 MPa, preferably of from 350 MPa to 700 MPa.

In an embodiment of the invention the film has
i) a tensile modulus (measured on a 40 μm monolayer test blown film according to ISO 527-3) in machine direction (MD) in the range of from 300 MPa to 500 MPa,
ii) a tensile modulus (measured on a 40 μm monolayer test blown film according to ISO 527-3) in transverse dircetion (TD) in the range of from 350 MPa to 600 MPa, and
iii) a dart-drop impact strength (DDI) determined according to ASTM D1709, method A on a 40 μm monolayer test blown film in the range of 350 to 1000 g.

In another embodiment of the invention the film has
i) a tensile modulus (measured on a 40 μm monolayer test blown film according to ISO 527-3) in machine direction (MD) in the range of from 450 MPa to 600 MPa,
ii) a tensile modulus (measured on a 40 μm monolayer test blown film according to ISO 527-3) in transverse dircetion (TD) in the range of from 500 MPa to 800 MPa, and
iii) a dart-drop impact strength (DDI) determined according to ASTM D1709, method A on a 40 μm monolayer test blown film in the range of 200 to 500 g.

The inventive films are fully recyclable and thus improves sustainability, as it is in the most preferred embodiment a “100% PE” solution with no other polymer than ethylene based polymers being present.

In another embodiment the inventive film contains at least 90 wt % of PE polymers, more preferably 95 to 99 wt % of PE polymers (difference to 100 wt % can be other polymers than PE), and is thus also suitable for being recycled.

The films according to the present invention are highly useful for being used in various packaging applications, wherein applications related to food packaging are preferred.

Furthermore the films according to the present invention may be used as a layer in multilayer polyethylene based blown films, preferably as core layer in multilayer polyethylene based blown films.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min.

The MFR is an indication of the flowability, and hence the processability, of the polymer. The higher the melt flow rate, the lower the viscosity of the polymer. The MFR is determined at 190° C. for polyethylene. MFR may be determined at different loadings such as 2.16 kg (MFR₂), 5 kg (MFR₅) or 21.6 kg (MFR₂₁).

Calculation of MFR, of Component B and of Fraction (A-2)

$$log A = x \cdot log B + ( 1 - x ) \cdot log C$$

$$C = {10}^{{\hat{}}^{\frac{( lo g A - x lo g β}{( 1 - x )}}}$$

For Component B:
B=MFR₂ of Component (A)
C=MFR₂ of Component (B)
A=final MFR₂ (mixture) of multimodal polyethylene copolymer (P)
X=weight fraction of Component (A)

For Fraction (A-2):
B=MFR₂ of 1^{st} fraction (A-1)
C=MFR₂ of 2^{nd} fraction (A-2)
A=final MFR₂ (mixture) of loop polymer (=Component (A))
X=weight fraction of the 1^{st} fraction (A-1)

### Density

Density of the polymer was measured according to ASTM; D792, Method B (density by balance at 23° C.) on compression moulded specimen prepared according to EN ISO 1872-2 (February 2007) and is given in kg/m³.

### Comonomer Contents:

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Advance Ill 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification.{klimke06, parkinson07, castignolles09} Standard single-pulse excitation was employed utilising the NOE at short recycle delays{pollard04, klimke06} and the RS-HEPT decoupling scheme{fillip05,griffin07}. A total of 1024 (1k) transients were acquired per spectra. Quantitative ¹³C{¹H} NMR spectra were processed, integrated and relevant quantitative properties determined from the integrals. All chemical shifts are internally referenced to the bulk methylene signal (6+) at 30.00 ppm.

The amount of ethylene was quantified using the integral of the methylene (6+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( 3 * B + 2 * H ) / 2$$

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

fBtotal=(Btotal/(Etotal+Btotal+Htotal)

The amount isolated 1-butene incorporated in EEBEE sequences was quantified using the integral of the *B2 sites at 38.3 ppm accounting for the number of reporting sites per comonomer:

$$B = {I}_{* B 2}$$

The amount consecutively incorporated 1-butene in EEBBEE sequences was quantified using the integral of the ααB2B2 site at 39.4 ppm accounting for the number of reporting sites per comonomer:

$$BB = 2 * I ααB2B2$$

The amount non consecutively incorporated 1-butene in EEBEBEE sequences was quantified using the integral of the ββB2B2 site at 24.7 ppm accounting for the number of reporting sites per comonomer:

$$BEB = 2 * I ββB2B2$$

Due to the overlap of the *B2 and *βB2B2 sites of isolated (EEBEE) and non-consecutivly incorporated (EEBEBEE) 1-butene respectively the total amount of isolated 1-butene incorporation is corrected based on the amount of non-consecutive 1-butene present:

$$B = {I}_{* B 2} - 2 * {I}_{ββ B 2 B 2}$$

The total 1-butene content was calculated based on the sum of isolated, consecutive and non consecutively incorporated 1-butene:

$$Btotal = B + BB + BEB$$

The total mole fraction of 1-butene in the polymer was then calculated as:

$$fB = ( Btotal / ( Etotal + Btotal + Htotal )$$

Characteristic signals corresponding to the incorporation of 1-hexene were observed and the comonomer fraction calculated as the fraction of 1-hexene in the polymer with respect to all monomer in the polymer:

$$fHtotal = ( Htotal / ( Etotal + Btotal + Htotal )$$

The amount isolated 1-hexene incorporated in EEHEE sequences was quantified using the integral of the *B4 sites at 39.9 ppm accounting for the number of reporting sites per comonomer:

$$H = {I}_{* B 4}$$

The amount consecutively incorporated 1-hexene in EEHHEE sequences was quantified using the integral of the ααB4B4 site at 40.5 ppm accounting for the number of reporting sites per comonomer:

$$HH = 2 * I ααB4B4$$

The amount non consecutively incorporated 1-hexene in EEHEHEE sequences was quantified using the integral of the ββB4B4 site at 24.7 ppm accounting for the number of reporting sites per comonomer:

$$HEH = 2 * I ββB4B4$$

The total mole fraction of 1-hexene in the polymer was then calculated as:

$$fH = ( Htotal / ( Etotal + Btotal + Htotal )$$

The mole percent comonomer incorporation is calculated from the mole fraction:

$$B [ mol \% ] = 100 * fB$$

$$H [ mol \% ] = 100 * fH$$

The weight percent comonomer incorporation is calculated from the mole fraction:

$$B [ wt \% ] = 100 * ( fB * 56.11 ) / ( ( fB * 56.11 ) + ( fH * 84.16 ) + ( ( 1 - ( fB + fH ) ) * 28.05 ) )$$

$$H [ wt \% ] = 100 * ( fH * 84.16 ) / ( ( fB * 56.11 ) + ( fH * 84.16 ) + ( ( 1 - ( fB + fH ) ) * 28.05 ) )$$

### REFERENCES

Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess, H. W., Wilhelm, M., Macromol. Chem. Phys. 2007; 208:2128.
Pollard, M., Klimke, K., Graf, R., Spiess, H. W., Wilhelm, M., Sperber, O., Piel, C., Kaminsky, W., Macromolecules 2004; 37:813.
Filip, X., Tripon, C., Filip, C., J. Mag. Resn. 2005, 176, 239
Griffin, J. M., Tripon, C., Samoson, A., Filip, C., and Brown, S. P., Mag. Res. in Chem. 2007 45, S1, S198
Castignolles, P., Graf, R., Parkinson, M., Wilhelm, M., Gaborieau, M., Polymer 50 (2009) 2373
Busico, V., Cipullo, R., Prog. Polym. Sci. 26 (2001) 443
Busico, V., Cipullo, R., Monaco, G., Vacatello, M., Segre, A. L., Macromoleucles 30 (1997) 6251
Zhou, Z., Kuemmerle, R., Qiu, X., Redwine, D., Cong, R., Taha, A., Baugh, D. Winniford, B., J. Mag. Reson. 187 (2007) 225
Busico, V., Carbonniere, P., Cipullo, R., Pellecchia, R., Severn, J., Talarico, G., Macromol. Rapid Commun. 2007, 28, 1128
Resconi, L., Cavallo, L., Fait, A., Piemontesi, F., Chem. Rev. 2000, 100, 1253

### Dart Drop Strength (DDI): Impact Resistance by Free-Falling Dart Method

This test method covers the determination of the energy that causes films to fail under specified conditions of impact of a free-falling dart from a specified height that would result in failure of 50% of the specimens tested (ASTM D1709; Alternative testing technique—method A).

By this technique, successive groups of twenty specimens each are tested. One missile weight is employed for each group and missile weight is varied in increments from group to group. Deviating from ASTM D1709-16a the test was performed on several film strips of a sample with at least 4 different weights. 20 specimens per weight were tested, so that a break range of 5%-95% was covered. It must be ensured that at least one weight is determined in the breaking range of 5%-25%, at least two weights in the breaking range of 30%-70%, and at least one weight in the breaking range of 75%-95%. The selection of the weights can be done in uneven steps. A film strip was taken across the width of the sample and measured on a thickness measuring device.

### Standard Conditions:

Conditioning time: >96 h
Test temperature: 23° C.
Dart head material: phenolic
Dart diameter: 38 mm
Drop height: 660 mm

### Results:

Impact failure weight—50% [g]

### Tensile Modulus

Tensile modulus (E-Mod (MPa) was measured in machine and/or transverse direction according to ISO 527-3 on film samples prepared as described under the Film Sample preparation with film thickness of 60 μm and at a cross head speed of 1 mm/min for the modulus.

### Film Sample Preparation

The test films consisting of the inventive blend and respective comparative polymers of 40 μm thickness, were prepared using a Collin 30 lab scale mono layer blown film line. The film samples were produced at 194° C., a 1:2.5 blow-up ratio, frostline distance of 120 mm.

### EXAMPLES

### Materials Used:

Multimodal Ziegler-Natta catalysed linear low density polyethylene (znLLDPE-1):
FX1001: multimodal alpha-olefin terpolymer commercially available by Borealis AG, with density of 931 kg/m³, a MFR₅ (190° C./5 kg) of 0.9 g/10 min, Tm 127° C.; produced with a Ziegler-Natta catalyst. It contains antioxidant.
For Comparative Example CE3 as mLLDPE: Anteo™ FK1820: bimodal ethylene/1-butene/1-hexene terpolymer with a density of 918 kg/m³, MFR₂ (190° C./2.16 kg) of 1.5 g/10 min, Tm 122° C., produced with a metallocene catalyst; commercially available from Borouge.

It contains antioxidant and processing aid.

### Cat.Example: Catalyst Preparation

### Loading of SiO2:

10 kg of silica (PQ Corporation ES757, calcined 600° C.) was added from a feeding drum and inertized in the reactor until 02 level below 2 ppm was reached.

### Preparation of MAO/tol/MC

30 wt % MAO in toluene (14.1 kg) was added into another reactor from a balance followed by toluene (4.0 kg) at 25° C. (oil circulation temp) and stirring 95 rpm. Stirring speed was increased 95 rpm→200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst

Reactor temperature was set to 10° C. (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Catalyst for Comparative Examples (CAT2)

As catalyst CAT2 an alumoxane containing, supported catalyst containing metallocene bis(1-methyl-3-n-butylcyclopentadienyl) zirconium (IV) chloride and with enhanced ActivCat® activator technology from Grace was used.

### Catalyst for Preparing znLLDPE for Inventive Examples IE4 and IE5, as Well as for Comparative Examples CE3, CE4 and CE5 (CAT3)

A solid polymerization catalyst component produced as described in Example 1 of EP 1378528 was used together with triethylaluminium cocatalyst so that the molar ratio of AI/Ti was about 15.

### Polymerization

Borstar pilot plant with a 3-reactor set-up (loop1—loop2—GPR 1) and a prepolymerization loop reactor.
mLLDPE (mLLDPE1—mLLDPE3) (for IE1, IE2, IE3, IE4 and IE5) and comparative mLLDPE (for CE1, CE2 and CE5) was produced by using the polymerization conditions as given in Table 1.
znLLDPE-2 (for IE4, IE5 and CE3) was produced by using the polymerization conditions as given in Table 3.

TABLE 1
Polymerization conditions for mLLDPE-1, mLLDPE-2,
mLLDPE-3 and comparative mLLDPE

| | | Com- | | |
|---|---|---|---|---|
| | | parative | | |
| | mLLDPE- | mLLDPE | | |
| | 1 for | for CE1, | mLLDPE- | |
| | IE1, IE2 | CE2 and | 2 | mLLDPE- |
| | and IE3 | CE3 | for IE4 | 3 for IE5 |
| Catalyst | CAT1 | CAT2 | CAT1 | CAT1 |
| Prepoly reactor | | | | |
| Catalyst feed (g/h) | 35 | 29.0 | 32 | 35 |
| Temp. (° C.) | 50 | 50.0 | 50 | 50 |
| Press. (kPa) | 5639 | 5718.9 | 5606 | 5617 |
| C2 (kg/h) | 4.0 | 4.0 | 4.0 | 4.0 |
| H2(g/h) | 0.04 | 0.04 | 0.03 | 0.03 |
| C4 (g/h) | 81.9 | 168.4 | 78.8 | 80.6 |
| Split (wt %) | 3.4 | 2.7 | 3.6 | 3.5 |
| loop 1 Fraction (A-1) | | | | |
| Temp. (° C.) | 85 | 85.0 | 85 | 85 |
| Press. (kPa) | 5544 | 5557.6 | 5606 | 5537 |
| C2 conc. (mol %) | 3.5 | 3.1 | 4.0 | 3.7 |
| H2/C2 ratio (mol/kmol) | 0.41 | 0.2 | 0.39 | 0.50 |
| C4/C2 ratio (mol/kmol) | 41 | 85.4 | 41.0 | 40 |
| Split (wt %) | 17.6 | 17.2 | 17.9 | 17.8 |
| Density (kg/m3) of loop 1 | 941 | 938 | 940.1 | 943 |
| material (fraction (A-1)) | | | | |
| MFR2 (g/10 min) | 5.0 | 3.2 | 2.2 | 10.0 |
| of loop 1 | | | | |
| material (fraction (A-1)) | | | | |
| loop 2 | | | | |
| Temp. (° C.) | 85 | 85.0 | 85 | 85 |
| Press. (kPa) | 5325 | 5365.5 | 5335 | 5337 |
| C2 conc. (mol %) | 3.5 | 3.1 | 4.2 | 4.1 |
| H2/C2 ratio (mol/kmol) | 0.6 | 0.1 | 0.5 | 0.5 |
| C4/C2 ratio (mol/kmol) | 29 | 88.4 | 27 | 28 |
| Split (wt %) | 20.4 | 19.2 | 20.7 | 20 |
| Density (kg/m3) after | 940.7 | 938.5 | 940.3 | 942.3 |
| loop 2 (component (A)) | | | | |
| MFR2 (g/10 min) after | 5.8 | 3.5 | 4.7 | 7.5 |
| loop 2 (component (A)) | | | | |
| MFR2 (g/10 min) | 6.8 | 3.7 | 10.4 | 5.5 |
| of loop 2 | | | | |
| material (fraction (A-2)) | | | | |
| Density (kg/m3) of loop 2 | 941 | 939 | 940.5 | 941 |
| material (fraction (A-2)) | | | | |
| C4 (wt %) after loop 2 | 1.21 | 1.03 | 1.19 | 1.21 |
| material (Component (A)) | | | | |
| GPR | | | | |
| Temp. (° C.) | 75.0 | 75.0 | 75 | 75 |
| Press. (kPa) | 2000.0 | 2000 | 2000 | 2000 |
| H2/C2 ratio (mol/kmol) | 1.18 | 0.2 | 1.02 | 1.05 |
| C6/C2 ratio (mol/kmol) | 14.5 | 36.2 | 11.78 | 14.04 |
| Split (wt %) | 58.6 | 61.0 | 57.9 | 58.7 |
| MFR2 (g/10 min) of GPR | 0.5 | 0.6 | 0.3 | 0.3 |
| material (Component (B)) | | | | |
| Density (kg/m3) of GPR | 891 | 899 | 900 | 891 |
| material (Component (B)) | | | | |
| C6 (wt %) of GPR | 18.60 | 15.41 | 12.08 | 18.23 |
| material Component (B)) | | | | |

The polymers were mixed with 2400 ppm of Irganox B561 and 270 ppm of Dynamar FX 5922 compounded and extruded under nitrogen atmosphere to pellets by using a JSW extruder so that the SEI was 230 kWh/kg and the melt temperature 250° C.

TABLE 2
Material properties of mLLDPE-1, mLLDPE-2,
mLLDPE-3 and Comparative LLDPE

| | | | | Com- |
|---|---|---|---|---|
| | mLLDPE- | mLLDPE- | mLLDPE- | parative |
| Material | 1 | 2 | 3 | LLDPE |
| MFR₂ (g/10 min) (final) | 1.3 | 1.0 | 1.0 | 1.2 |
| MFR₂₁ (g/10 min) | 38.7 | 29.6 | 30.1 | 22.9 |
| MFR₂₁/MFR₂ | 29.8 | 29.6 | 30.1 | 19.1 |
| Density (kg/m³) | 913 | 917 | 913 | 915 |
| C4 (wt %) | 0.5 | 0.5 | 0.5 | 0.4 |
| C6 (wt %) | 10.7 | 7.0 | 10.9 | 9.4 |
| MFR₂(A)/MFR₂(final) | 4.5 | 4.7 | 7.5 | 3.1 |

TABLE 3
Polymerization conditions for znLLDPE-2

| | znLLDPE-2 |
|---|---|
| Prepoly reactor | |
| Temperature (° C.) | 70 |
| Pressure (kPa) | 5777 |
| Split (wt %) | 2 |
| First loop reactor | |
| Temperature (° C.) | 95 |
| Pressure (kPa) | 5503 |
| C2 (mol %) | 4.9 |
| H2/C2 (mol/kmol) | 308 |
| MFR2 (g/10 min) of homopolymer fraction (A-1) | 205 |
| Density of homopolymer fraction (A-1) | 970 |
| Split (wt%) | 18 |
| Second loop reactor | |
| Temperature (° C.) | 95 |
| Pressure (kPa) | 5392 |
| C2 (mol %) | 5.6 |
| H2/C2 (mol/kmol) | 606 |
| Split (wt %) | 26 |
| Density (kg/m³) after loop 2 (homopolymer (A)) | 970 |
| MFR2 (g/10 min) after loop 2 (homopolymer (A)) | 420 |
| Density (kg/m³) of homopolymer fraction (A-2) | 970 |
| MFR2 (g/10 min) of homopolymer fraction (A-2) | 729 |
| Gas phase reactor | |
| Temperature (° C.) | 82 |
| Pressure (kPa) | 1985 |
| C2 (mol %) | 13.2 |
| H2/C2 (mol/kmol) | 22.0 |
| C4/C2 (mol/kmol) | 98.1 |
| C6/C2 (mol/kmol) | 128.0 |
| Split (wt %) | 54 |

TABLE 4
Material properties of znLLDPE-2

| Material | znLLDPE-2 |
|---|---|
| MFR₂ (g/10 min) (final) | 0.38 |
| MFR₅ (g/10 min) (final) | 1.58 |
| MFR₂₁ (g/10 min) (final) | 35.2 |
| Density (kg/m³) | 941 |
| C4 (wt %) | 0.9 |
| C6 (wt %) | 3.1 |

Monolayer Blown Films

The above produced mLLDPEs were blended with FX1001 or znLLDPE-2 directly on the film extrusion line.

The following films have been produced with the above described method (film sample preparation).

TABLE 5
Inventive and Comparative Films

| | | IE1 | CE1 | IE2 | IE3 | CE2 | IE4 | CE3 | IE5 | CE4 |
|---|---|---|---|---|---|---|---|---|---|---|
| FX1001 | wt % | 90 | 90 | 75 | 55 | 55 | — | — | — | — |
| znLLDPE-2 | w % | — | — | — | — | — | 75 | 75 | 75 | 75 |
| mLLDPE-1 | wt % | 10 | — | 25 | 45 | — | — | — | — | — |
| Comparative | wt % | — | 10 | — | — | 45 | — | — | — | 25 |
| mLLDPE | | | | | | | | | | |
| mLLDPE-2 | wt % | — | — | — | — | — | 25 | — | — | — |
| mLLDPE-3 | wt % | — | — | — | — | — | — | — | 25 | — |
| FK1820 | wt % | — | — | — | — | — | — | 25 | — | |
| TM/MD | MPa | 406 | 383 | 358 | 303 | 310 | 507 | 497 | 490 | 465 |
| TM/TD | MPa | 518 | 457 | 452 | 371 | 322 | 680 | 718 | 683 | 611 |
| DDI | g | 402 | 360 | 540 | 888 | 546 | 271 | 212 | 355 | 249 |

The data demonstrates that using the specific mLLDPEs as blend partner for the znLLDPE leads to an improved balance of stiffness and toughness compared to films, where the Comparative mLLDPE or FK1820 has been used.

1.-14. (canceled)

15. Monolayer polyethylene blown film, comprising:
a) 50.0 wt % to 95.0 wt %, based on a total weight of the monolayer polyethylene blown film, of a multimodal Ziegler-Natta catalysed linear low density polyethylene (znLLDPE) having a density in a range of from 925 to 950 kg/m³ (ISO 1183) and an MFR₅ (190° C., 5 kg, ISO 1133) in a range of from 0.1 to 6.0 g/10 min; and
b) 5.0 wt % to 50.0 wt %, based on the total weight of the monolayer polyethylene blown film, of a multimodal metallocene catalysed linear low density polyethylene (mLLDPE) having a density in a range of from 880 to 925 kg/m³ (ISO 1183), an MFR₂ (190° C., 2.16 kg, ISO 1133) in a range of from 0.1 to 6.0 g/10 min and a ratio of an MFR₂₁ (190° C., 21.6 kg, ISO 1133) to MFR₂ (190° C., 2.16 kg, ISO 1133), MFR₂₁/MFR₂, in a range of from 22 to 50;
with total amounts of a)+b) summing up to 100 wt %.

16. Monolayer polyethylene blown film according to claim 15, wherein the multimodal metallocene catalysed linear low density polyethylene (mLLDPE) consists of:
an ethylene polymer component (A), which consists of an ethylene polymer fraction (A-1) and an ethylene polymer fraction (A-2), and an ethylene polymer component (B).

17. Monolayer polyethylene blown film according to claim 15, wherein the multimodal metallocene catalysed linear low density polyethylene (mLLDPE) is a copolymer of ethylene with 1-butene and 1-hexene, whereby:
a total amount of 1-butene, based on the multimodal metallocene catalysed linear low density polyethylene (mLLDPE), is in a range of from 0.1 to 1.0 wt %, and/or 0.2 to 0.8 wt %, and/or 0.3 to 0.6 wt %; and
a total amount of 1-hexene, based on multimodal metallocene catalysed linear low density polyethylene (mLLDPE), is in a range of from 2.0 to 20.0 wt %, and/or 4.0 to 18.0 wt %, and/or 6.0 to 15.0 wt %.

18. Monolayer polyethylene blown film according to claim 16, wherein in the multimodal metallocene catalysed linear low density polyethylene (mLLDPE), a total amount (wt %) of 1-butene present in the ethylene polymer component (A) is in a range of 0.5 to 5.0 wt %, and/or of 0.6 to 4.0 wt %, and/or of 0.8 to 3.0 wt %, and/or of 1.0 to 2.0 wt %, based on the ethylene polymer component (A); and
a total amount (wt %) of 1-hexene present in the ethylene polymer component (B) is in a range of 15.0 to 25.0 wt %, and/or of 16.0 to 22.0 wt %, and/or of 17.0 to 20.0 wt %, based on the ethylene polymer component (B).

19. Monolayer polyethylene blown film according to claim 16, wherein in the multimodal metallocene catalysed linear low density polyethylene (mLLDPE) the ethylene polymer fraction (A-1) has a MFR₂ (190° C., 2.16 kg, ISO 1133) in a range of from 1.0 to 15.0 g/10 min, and/or of from 1.5 to 13.0 g/10 min, and/or of from 2.0 to 11.0 g/10 min, and/or of from 2.5 to 10.0 g/10 min; and
the ethylene polymer fraction (A-2) has a MFR₂ (190° C., 2.16 kg, ISO 1133) in a range of from 2.0 to 30.0 g/10 min, and/or of from 2.5 to 20.0 g/10 min, and/or of from 3.0 to 15.0 g/10 min, of from 3.5 to 10.0 g/10 min; and/or wherein
the ethylene polymer component (A) has a MFR₂ in a range of from 2.0 to 30 g/10 min, and/or from 2.5 to 20 g/10 min, and/or of from 3.0 to 15 g/10 min, and/or of from 3.2 to 10 g/10 min; and
the ethylene polymer component (B) has a MFR₂ in a range of from 0.01 to 1.5 g/10 min, and/or of from 0.05 to 1.2 g/10 min, and/or of from 0.1 to 1.0 g/10 min, and/or of from 0.2 to 0.8 g/10 min and/or wherein
a ratio of the MFR₂ of ethylene polymer component (A) to the MFR₂ of the mLLDPE is at least 2.5 to 20.0, and/or 3.0 to 15.0 and/or of 3.5 to 10.0.

20. Monolayer polyethylene blown film according to claim 16, wherein in the multimodal metallocene catalysed linear low density polyethylene (mLLDPE) a density of the ethylene polymer component (A) is in a range of from 920 to 950 kg/m³, and/or of from 925 to 950 kg/m³, and/or from 930 to 945 kg/m³, and/or a density of the ethylene polymer component (B) is in a range of from 880 to 915 kg/m³, and/or of from 885 to 910 kg/m³, and/or in a range of from 890 to 905 kg/m³; and/or
the polymer fraction (A-1) has a density in a range of from 920 to 960 kg/m³, and/or of 925 to 955 kg/m³, and/or of 930 to 950 kg/m³, and/or of 935 to 945 kg/m³; and
a density of the polymer fraction (A-2) is in a range of from 930 to 950 kg/m³, and/or of 935 to 945 kg/m³, whereby the density of polymer fractions (A-1) and (A-2) is the same or is different.

21. Monolayer polyethylene blown film according to claim 15, wherein the multimodal metallocene catalysed linear low density polyethylene (mLLDPE) is produced in a presence of metallocene complex of formula (1): 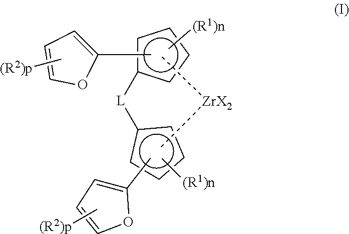
wherein each X is independently a halogen atom, a C₁₋₆-alkyl, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R₁ is the same or different and is a C₁₋₆-alkyl group or C₁₋₆-alkoxy group;
each n is 1 to 2;
each R₂ is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

22. Monolayer polyethylene blown film according to claim 15, wherein the multimodal Ziegler-Natta catalysed linear low density polyethylene (znLLDPE) comprises:
(A) a lower molecular weight (LMW) homopolymer of ethylene; and
(B) a higher molecular weight (HMW) terpolymer of ethylene, 1-butene and 1-hexene wherein the LMW homopolymer fraction (A) has a lower molecular weight than the HMW terpolymer fraction (B); and
the lower molecular weight (LMW) fraction (A) of the znLLDPE has a melt index MFR₂ according to ISO 1133 (190° C.) in a range of 200 to 1000 g/10 min, and/or of 250 to 800 g/10 min;
a density according to ISO 1183 in a range of 940 to 980 kg/m³, and/or 945 to 975 kg/m³; and
a comonomer content in a range of 0 to 2.5 mol %, and/or 0 to 2.0 mol %; and
the higher molecular weight (HML) fraction (B) has a lower MFR₂ and a lower density than the lower molecular weight fraction (A).

23. Monolayer polyethylene blown film according to claim 22, wherein the lower molecular weight (LMW) homopolymer of ethylene (A) consists of:
two homopolymer fractions (A-1) and (A-2), wherein the homopolymer fraction (A-1) has a MFR₂ according to ISO 1133 (190° C.) in a range of 100 to 400 g/10 min, and/or in a range of 150 to 300 g/10 min, whereas the homopolymer fraction (A-2) has a MFR₂ according to ISO 1133 (190° C.) in a range of 450 to 1200 g/10 min, and/or in a range of 600 to 1100 g/10 min, and whereby the MFR₂ of fraction (A-1) is lower than the MFR₂ of a total lower molecular weight (LMW) homopolymer of ethylene (A); and/or
a density of each of the two homopolymer fractions (A-1) and (A-2) is the same or is different and is in a range of 955 to 980 kg/m³, and/or 965 to 980 kg/m³ or 965 to 975 kg/m³.

24. Monolayer polyethylene blown film according to claim 15, wherein the film comprises:
a dart-drop impact strength (DDI) determined according to ASTM D1709, method A on a 40 μm monolayer test blown film of at least 150 g up to 1200 g, and/or 200 g up to 1100 g, and/or 250 g up to 1000 g.

25. Monolayer polyethylene blown film according to claim 15, wherein the film comprises:
in addition a tensile modulus (measured on a 40 μm monolayer test blown film according to ISO 527-3) in machine direction (MD) in a range of from >250 MPa to 700 MPa, and/or of from 300 MPa to 600 MPa and in transverse direction (TD) in a range of from >300 MPa to 800 MPa, and/or of from 350 MPa to 700 MPa.

26. Monolayer polyethylene blown film according to claim 15, wherein the film comprises:
i) a tensile modulus (measured on a 40 μm monolayer test blown film according to ISO 527-3) in machine direction (MD) in a range of from 300 MPa to 500 MPa;
ii) a tensile modulus (measured on a 40 μm monolayer test blown film according to ISO 527-3) in transverse direction (TD) in a range of from 350 MPa to 600 MPa; and
ii) a dart-drop impact strength (DDI) determined according to ASTM D1709, method A on a 40 μm monolayer test blown film in a range of 350 to 1000 g.

27. Monolayer polyethylene blown film according to claim 15, wherein the film comprises:
i) a tensile modulus (measured on a 40 μm monolayer test blown film according to ISO 527-3) in machine direction (MD) in a range of from 450 MPa to 600 MPa;
ii) a tensile modulus (measured on a 40 μm monolayer test blown film according to ISO 527-3) in transverse direction (TD) in a range of from 500 MPa to 800 MPa; and
iii) a dart-drop impact strength (DDI) determined according to ASTM D1709, method A on a 40 μm monolayer test blown film in a range of 200 to 500 g.

28. Monolayer polyethylene film according to claim 15, configured in combination as a packing material for food and/or medical products.
